(19) United States
(12) Patent Application Publication
(10) Pub. No.: US 2024/0329941 A1
(43) Pub. Date: Oct. 3, 2024

(54) APPARATUS AND METHOD FOR MANAGING COMPONENTS RECOMMENDATION IN APPLICATION BUILDER

(71) Applicant: RAKUTEN SYMPHONY, INC., Tokyo (JP)

(72) Inventors: Md Nizam UDDIN, Tokyo (JP); Mingyeh LEE, Tokyo (JP)

(73) Assignee: RAKUTEN SYMPHONY, INC., Tokyo (JP)

(21) Appl. No.: 18/192,734

(22) Filed: Mar. 30, 2023

(51) Int. Cl. G06F 8/34; G06F 8/33

(52) U.S. Cl. CPC G06F 8/34; G06F 8/33

(57) ABSTRACT

Provided are apparatus, method, and system for managing components recommendation in an application builder. According to embodiments, the apparatus may include: at least one memory storage storing computer-executable instructions; and at least one processor communicatively coupled to the memory storage. The at least one processor may be configured to execute the computer-executable instructions to: determine a first recommendation of components among multiple available components; provide the first recommendation to a user; receive a user input from the user; determine, based on the user input, a second recommendation of components among the available components; and provide the second recommendation to the user.

### TECHNICAL FIELD

Systems, methods, and apparatuses consistent with example embodiments of the present disclosure relate to application builders, and more specifically, relate to management of components recommendation in low-code and/or no-code application builders.

### BACKGROUND

In the related art, a low-code and/or no-code application builder (may be referred to as “App builder” hereinbelow) is a platform or a system which allows a user, who may not have experience or skill in coding, to build an application by, for example, configuring and selecting components (e.g., pre-configured functional components, pre-defined design components, etc.) from at least one graphical user interface (GUI). For instance, the user may build an application via an App builder by, for example, drag-and-drop of desired components to the desired locations in the GUI. Nevertheless, as discussed hereinbelow, there are several shortcomings in related art App builder in the provision of components for user selection.

To begin with, in the related art App builder, the number of selectable components may be huge, which may in turn result in a situation of choice overload. For instance, the users of the App builder may be overwhelmed and/or be confused by the significant amount of choices and may have difficulty in quickly and effectively choosing appropriate component(s) from the selectable components.

Particularly, for inexperienced users who are not familiar with the functionality and/or stylistic representation of the components, said users may need to choose the component(s) on trial-and-error basis, may contact other user(s) for consultation, or the like, in order to select the appropriate component(s) that fulfill their requirement. On the other hand, for experienced users who have already knew what component(s) to choose, said users may still need to navigate through all available components (e.g., scroll through the list of components, search for the desired component(s) from among a significant amount of components, etc.), in order to pick up the desired component(s).

In view of the above, the choice overload issue in the related art App builder may be burdensome for the users and may reduce the efficiency of the users in building an application via the App builder.

### SUMMARY

The apparatus, method, system, device, or the like, provided by example embodiments of the present disclosure may automatically determine and provide one or more recommendations of one or more components to one or more users of a low-code and/or no-code application builder, which effectively reduces (if not totally avoids) the choice overload issue in the related art.

According to embodiments, an apparatus is provided. The apparatus may include: at least one memory storage storing computer-executable instructions; and at least one processor communicatively coupled to the memory storage, wherein the at least one processor may be configured to execute the computer-executable instructions to: determine a first recommendation of components among multiple available components; provide the first recommendation to a user; receive a user input from the user; determine, based on the user input, a second recommendation of components among the available components; and provide the second recommendation to the user.

According to embodiments, a method is provided. The method may be performed by at least one processor, and may include: determining a first recommendation of components among multiple available components; providing the first recommendation to a user; receiving a user input from the user; determining, based on the user input, a second recommendation of components among the available components; and providing the second recommendation to the user.

Additional aspects will be set forth in part in the description that follows and, in part, will be apparent from the description, or may be realized by practice of the presented embodiments of the disclosure.

### BRIEF DESCRIPTION OF THE DRAWINGS

Features, Advantages, and Significance of Exemplary Embodiments of the Disclosure Will be Described Below with Reference to the Accompanying Drawings, in which Like Signs Denote Like Elements, and Wherein:

FIG. 1 illustrates a block diagram of an example system for managing components recommendation in an application builder, according to one or more embodiments;

FIG. 2 illustrates an example block diagram of a method for managing one or more recommendations of one or more components, according to one or more embodiments;

FIG. 3A illustrates an example of a tree-based recommendation model, according to one or more embodiments;

FIG. 3B illustrates an example of a stochastic-based recommendation model, according to one or more embodiments;

FIG. 4A illustrates an example GUI presented to the user, according to one or more embodiments;

FIG. 4B illustrates another example GUI presented to the user, according to one or

more embodiments;

FIG. 4C illustrates yet another example GUI presented to the user, according to one or more embodiments;

FIG. 5 is a diagram of an example environment in which systems and/or methods, described herein, may be implemented, according to one or more embodiments; and

FIG. 6 is a diagram of example components of a device, according to one or more embodiments

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide apparatus, systems, methods, or the like, which may automatically determine and provide one or more recommendations of one or more components (may be referred to as “components recommendation” herein) to one or more users of a low-code and/or no-code application builder. According to embodiments, different components recommendations may be provided to the user under different circumstances, based on the user input.

Ultimately, example embodiments of the present disclosure effectively provide components recommendation to users of low-code and/or no-code application builder, which in turn reduces (if not totally avoids) the choice overload issue in the related art. For instance, an inexperienced user may be guided to effectively choose an appropriate component based on the components recommendation. Additionally, an experienced user may quickly pick up the desired component(s) without requiring to navigate through all available components. Thus, example embodiments of the present disclosure reduce the burden of the users in selecting a component(s), improve user experience in utilizing the low-code and/or no-code application builder, and improve the efficiency of the users in building an application in the low-code and/or no-code application builder.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the system, apparatus, method, or the like, of the present disclosure, according to one or more embodiments, are provided in the following.

### Example System Architecture

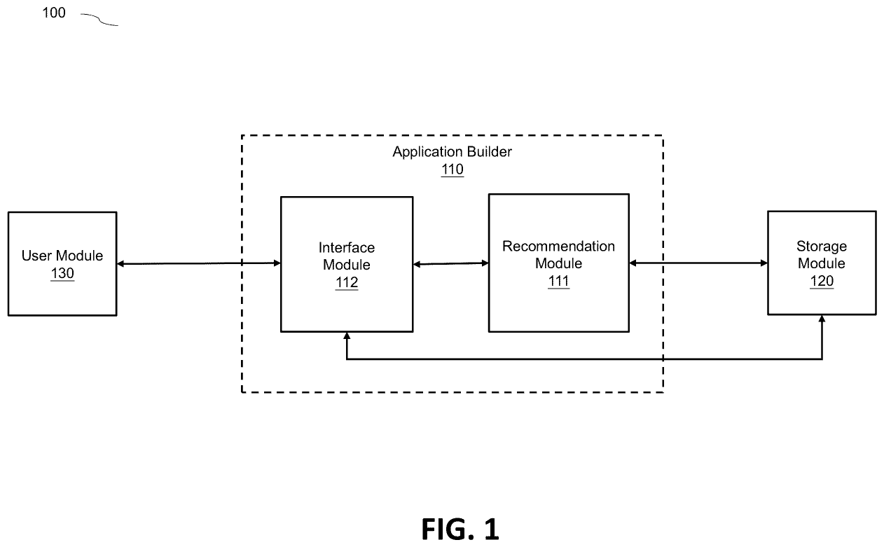

FIG. 1 illustrates a block diagram of an example system 100 for managing components recommendation in an application builder, according to one or more embodiments. For instance, system 100 may be utilized for managing recommendation of one or more functional components (e.g. button, text box, list, scroll bar, view box, etc.), or the like, for users of the application builder.

Referring to FIG. 1, system 100 may include an application builder 110 (may be referred to as “App builder 110” herein), a storage module 120, and a user module 130.

In general, a user may utilize the user module 130 to access and to utilize the App builder 110 to build one or more applications. In response to one or more user inputs, the App builder 110 may retrieve data or information from the storage module 120, and may provide, amongst other operations, management of components recommendation (e.g., providing components recommendation(s), updating components recommendation(s), etc.) to the user via the user module 130.

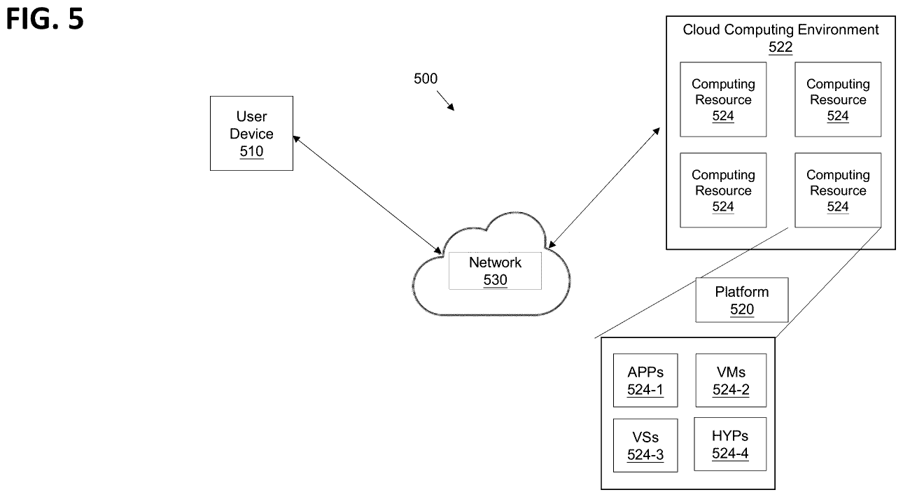

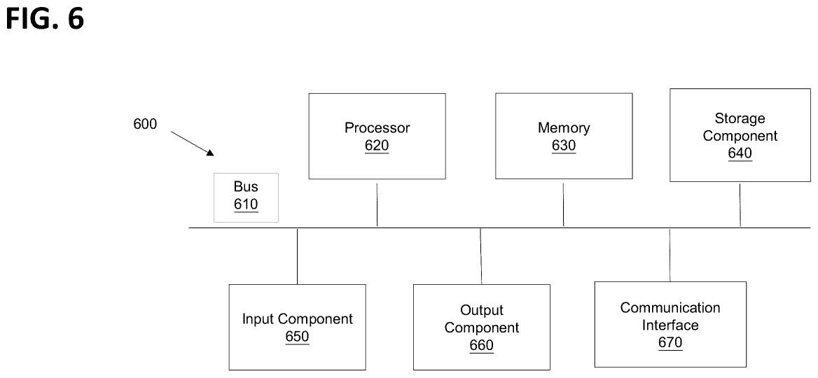

In this regard, the user module 130 may include any suitable module, equipment, terminal, device, machine, or the like, which enables one or more users to access and to utilize the App builder 110. For instance, module 130 may include any type of computing, networking, or mobile device, including but not limited to mobile devices and phones such as cellular phones (e.g., any “smart phone”), a personal computer, server computer, or laptop computer; personal digital assistants (PDAs); a roaming device, such as a network-connected roaming device; a wireless device such as a wireless email device or other device capable of communicating wireless with a computer network; or any other type of network device that may communicate over a network and handle electronic transactions. Any discussion of any user module mentioned herein may also apply to other devices, such as devices including short-range ultra-high frequency (UHF) device, near-field communication (NFC) module, infrared (IR) module, controller area network (CAN) module, universal serial bus (USB) module, high definition multimedia interface (HDMI) module, a Bluetooth™ module, and Wi-Fi module, among others. Alternatively or additionally, the user module 130 may include one or more devices described below with reference to user device 510 in FIG. 5, and/or may include one or more components described below with reference to device 600 in FIG. 6.

The storage module 120 may include any suitable storage medium, such as a server, a web storage, a memory device, and the like, which may store data and information associated with the App builder. For instance, the storage module 120 may be configured to store and to provide users information, such as credentials of each user (e.g., user ID, etc.), role of each user (e.g., new/junior developer, experienced/senior developer, individual user, etc.), usage history of one or more users, project(s) associated with each user, team or user group associated with each user, or the like. According to embodiments, the information of each user may be aggregated, be stored, or be recorded in a respective user profile stored in the storage module 120.

In addition, the storage module 120 may be configured to store and to provide components data or information, such as information of available components, information of component(s) associated with each type of user and/or each type of project, information of interactive element(s) associated with each component, information of graphical and/or stylistic presentation of each component, or the like. According to embodiments, the information of each component may be aggregated, be stored or be recorded in a respective component profile stored in the storage module 120.

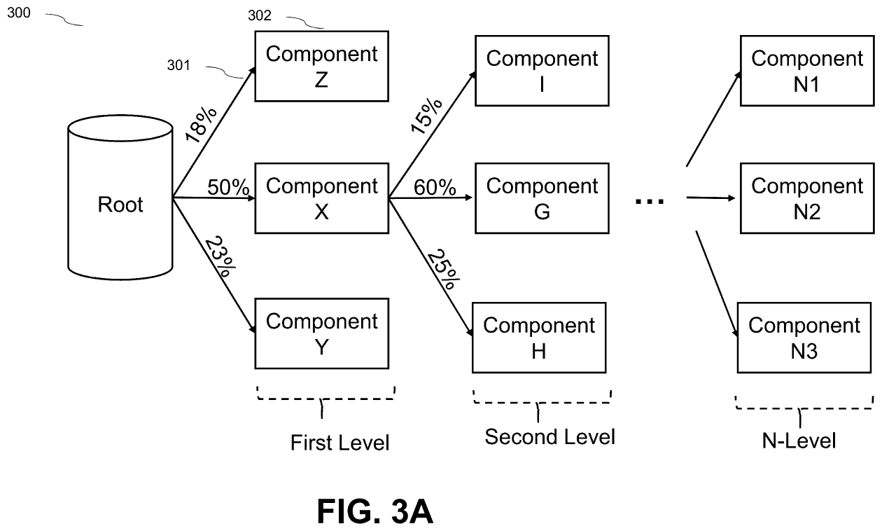

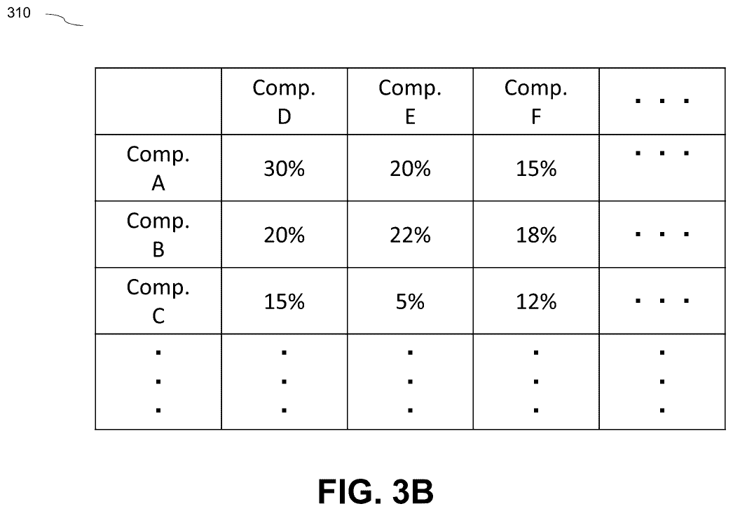

Further, the storage module 120 may be configured to store and to provide one or more recommendation models, such as one or more sequential recommendation models, as well as the associated information such as information of associated component(s) or component profile(s), information of associated user(s) or user profile(s), training schedule, training algorithms, or the like. The one or more sequential recommendation models may include one or more tree-based models (discussed below with reference to FIG. 3A), one or more stochastic-based models such as one or more Markov chain models (discussed below with reference to FIG. 3B), and the like. It can be understood that the storage module 120 may be configured to store and to provide any other suitable information, without departing from the scope of the present disclosure.

Furthermore, the storage module 120 may be implemented in a plurality of servers (e.g., a server cluster) or in a plurality of databases in one location or in different locations. Alternatively or additionally, the storage module 120 may include a plurality of sub-storages, each of which may be configured to store and to provide different information. For instance, the storage module 120 may include a first sub-storage for storing users information, may include a second sub-storage for storing components information, and may include a third sub-storage for storing recommendation models.

The App builder 110 may include a low-code application builder, a no-code application builder, or a combination thereof. As illustrated in FIG. 1, the App builder 110 may include a recommendation module 111 and an interface module 112, although it can be understood that the App builder 110 may also include any other suitable module(s) for providing any suitable operation(s), without departing from the scope of the present disclosure.

According to embodiments, the App builder 110 (or one or more modules included therein) may be deployed in the form of computer-executable software program or application. For instance, the App builder 110 (or one or more modules included therein) may be deployed in the form of computer-readable or computer-executable instructions which, when being executed by at least one processor of an apparatus or a device (e.g., user module 130), cause the at least processor to perform one or more operations of the App builder 110 as described herein.

Alternatively, the App builder 110 described herein may refer to an apparatus, a device, or the like, that include at least one memory storage storing computer-executable instructions and at least one processor communicatively coupled to the memory storage, wherein the at least one processor may be configured to execute the computer-executable instructions to perform one or more operation as described herein. For instance, the App builder 110 may include a server, a computing system, or the like, which include the at least one memory storage and the at least one processor and perform one or more operations described herein. In that case, the user module 130 may communicatively couple to said apparatus, or the like, to utilize the App builder 110.

The recommendation module 111 of the App builder 110 may be configured to determine, based on one or more recommendation models, one or more recommendations of one or more components and to provide the determined one or more recommendations to other modules for further processing. For instance, the recommendation module 111 may provide the one or more recommendations to the interface module 112 such that the interface module 112 may utilize said one or more recommendations to generate one or more graphical user interfaces (GUIs), may provide the one or more recommendations to the storage module 120 for storing, may provide the one or more recommendations for training one or more recommendation models, or the like.

According to embodiments, the recommendation module 111 may determine and may provide the one or more recommendations under various circumstances or scenarios. For instance, the recommendation module 111 may determine and provide a first recommendation of component(s) when the user has not yet selected any component in the App builder 110 (when the user first accessing to the App builder 110, etc.), may determine and provide a second recommendations of component(s) when the user has selected a component (or an interactive element associated therewith) in the App builder 110, or the like.

On the other hand, interface module 112 of the App builder 110 may be configured to communicatively couple the App builder 110 (or modules included therein such as recommendation module 111) to the user module 130. According to embodiments, the interface module 112 may generate one or more GUIs and present the one or more GUIs to the user module 130, may receive one or more user inputs from the presented one or more GUIs, and may provide the received one or more user inputs to one or more other modules (e.g., recommendation module 111, storage module 120, etc.) for further processing.

For instance, upon detecting an access from a non-login user, the interface module 112 may generate and present a login GUI to the user, so as to allow the user to login to the system by inputting the associated credentials (e.g., user ID, password, etc.) via the login GUI. In this regard, the interface module 112 may receive the user's credentials (e.g., via the login GUI) and provide the same to a user management module (included in or external from the App builder 110) for authorizing and authenticating the user.

Upon successful user login, the interface module 112 may retrieve, based on the user's credentials, user information (e.g., user profile, etc.) from the storage module 120 and provide the same to the recommendation module 111. Alternatively, the interface module 112 may provide the user's credentials to the recommendation module 111 and the recommendation module 111 may retrieve the user information (e.g., user profile, etc.) from the storage module 120 based thereon.

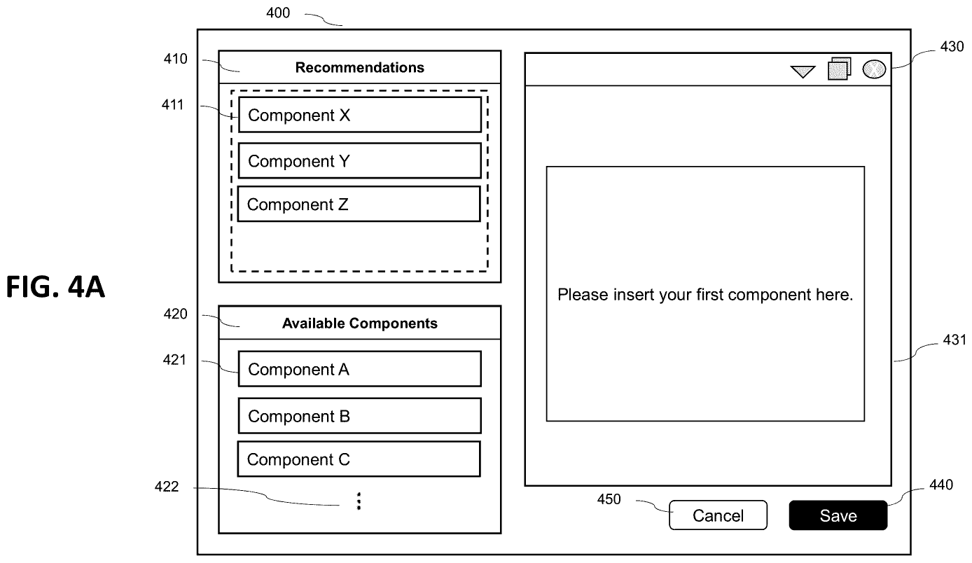

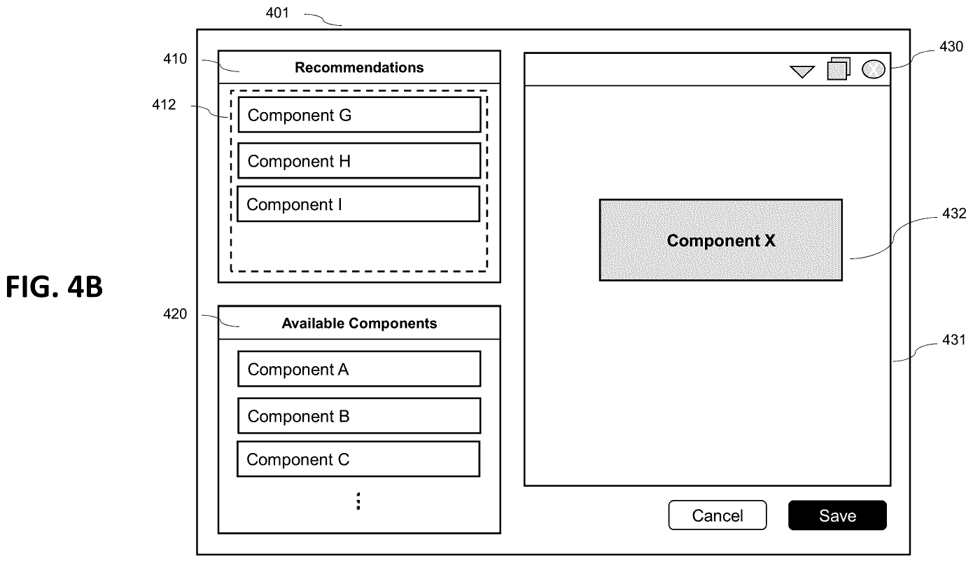

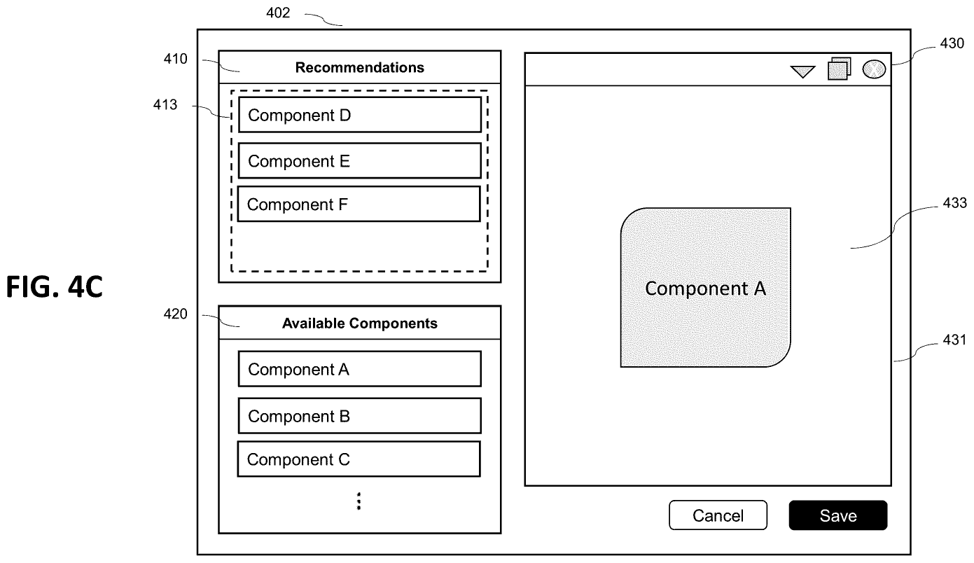

Further, upon successful user login, the interface module 112 may generate one or more GUIs and may present the one or more GUIs to the user. For instance, the interface module 112 may obtain information of available components (e.g., obtain from the storage module 120, provided by the recommendation module 111, etc.) and information of a first recommendation of components (e.g., obtain from the recommendation module 111), and may generate a GUI (further described below with reference to FIG. 4A) for presenting one or more available functional components and the first recommendation of components to the user.

Subsequently, the interface module 112 may receive one or more user inputs from the user module 130 via the GUI, and may provide the received user input(s) to the storage module 120 for storing and/or to the recommendation module 111 for further processing. The user input(s) may be utilized for determining further components recommendation(s) and/or may be utilized for training one or more recommendation models.

Further, the interface module 112 may receive information of a subsequent recommendation(s) of components from the recommendation module 111, and may update the GUI (further described below with reference to FIG. 4B and FIG. 4C) to present the subsequent recommendation(s) to the user.

To this end, the App builder 110 (or the recommendation module 111 and/or the interface module 112 included therein) may dynamically determine and provide one or more recommendations of one or more components to the user when the user is accessing and/or is utilizing the App builder 110.

One or more of App builder 110 (or one or more modules included therein) and storage module 120 may be implemented in an environment described below with reference to FIG. 5, and may include or may be utilized by one or more components described below with reference to FIG. 6.

Furthermore, it is contemplated that the configuration of system 100 may be arranged in a manner different from those described hereinabove, without departing from the scope of the present disclosure. For instance, system 100 may include more than one user module 130, App builder 110 may include additional modules, and the like.

In addition, one or more of the recommendation module 111, the interface module 112, and the storage module 120 may be combined to each other and function as one module. For example, the recommendation module 111 may be configured to perform one or more operations of the interface module 112, the recommendation module 111 and the interface module 112 may be configured to perform one or more operations of one another, and the like. Further, it is contemplated that the App builder 110 may act as one module with combined functionalities and roles of the interface module 111 and interface module 112, without departing from the scope of the present disclosure.

In the following, descriptions of several example operations of the App builder 110 (or modules 111-112 included therein) in managing components recommendations, according to one or more embodiments, are provided.

### Example Operations of the App Builder

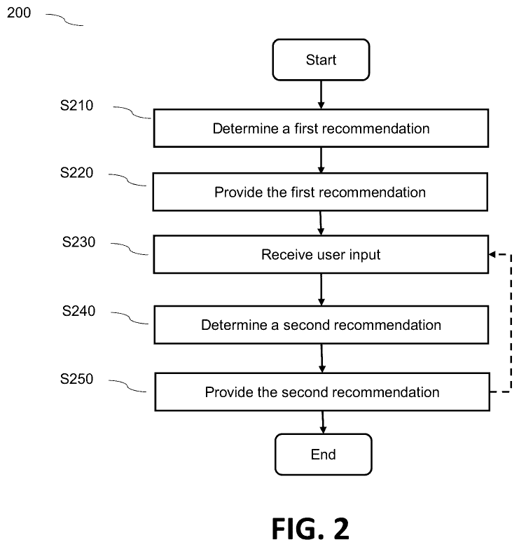

FIG. 2 illustrates a block diagram of an example method 200 for managing one or more recommendations of one or more components, according to one or more embodiments. Method 200 may be performed by the App builder 110 (or the recommendation module 111 and the interface module 112 included therein), or may be performed by at least one processor of an apparatus (e.g., a user module 130, a server hosting or deploying the App builder 110, etc.) when the at least one processor executes computer-executable instructions (e.g., instructions stored in at least one memory storage such as the storage module 120, etc.) to perform functions or operations of the App builder 110 (or functions/operations of the recommendation module 111 and the interface module 112 included therein).

For descriptive purpose, it may be assumed that method 200 is initiated when a user has successfully login to the system, and that the user have not selected any component in the App builder 110.

In general, when a user first accessing to the App builder 110, the App builder 110 may determine a first recommendation of components among multiple available components (at operation S210) and provide the first recommendation to the user (at operation S220). For instance, the App builder 110 may generate a graphical user interface (GUI) including interactive elements associated with available components and components of the first recommendations, to allow the user to build an application by interacting with said interactive elements therefrom. Further, the App builder 110 may receive one or more user inputs from the user (at operation S230), may determine a second recommendation of components among the available components (at operation S240), and may provide the second recommendation to the user (at operation S250). One or more operation of method 200 may be performed repeatedly or reiteratively.

Further descriptions of each of the operations S210 to S250 are provided in the following. In this regard, one or more of the operations S210 to S250 may be described along with examples of recommendation model illustrated in FIG. 3A and FIG. 3B, as well as several example GUIs illustrated in FIG. 4A to FIG. 4C.

### Operation S210: Determining a First Recommendation

Referring to FIG. 2, at operation S210, a first recommendation of one or more components (may be referred to as “first recommendation” or “first recommendation of components” herein) are determined. According to embodiments, the recommendation module 111 (or at least one processor performing the functions of the recommendation module 111) may be configured to determine the first recommendation of components among multiple available components. By way of example, assuming that multiple components (e.g., functional components such as button and text box, design components such as background, etc.) are available in the App builder 110 for the user selection, the recommendation module 111 (or the at least one processor) may determine, at operation S210, which of the available components should be recommended to the user in the first recommendation.

According to embodiments, the recommendation module 111 (or the at least one processor) may obtain, from one or more storage mediums (e.g., storage module 120), information of available components (may be referred to as “components information” herein), and/or information of the user (may be referred to as “user information” herein), may select a first recommendation model based on the components information and/or the user information, and may determine the first recommendation of components from among the available components based on the first recommendation model.

For instance, the recommendation module 111 (or the at least one processor) may receive, from the interface module 112, user credentials (e.g., user ID provided by the user via the user module 130 during login process, etc.), and may then obtain, from the one or more storage mediums and based on the user credentials, a user profile containing the user information and/or a components profile containing the components information. The user information may include the role of the user, the project associated with the user, the information of other user(s) associated with the user (e.g., user from the same team, user working on the same/similar project, etc.), or the like. The components information may include the availability of the components, the type of the components, the popularity of the components (e.g., popularity in a specific type of project, popularity among users of a specific type, etc.), or the like.

Upon obtaining the components information and the user information, the recommendation module 111 (or the at least one processor) may select, determine, or obtain a first recommendation model for determining the first recommendation. By way of example, the recommendation module 111 (or the at least one processor) may determine, based on the user information, components most relevant to the user (e.g., components mostly used by other users in a similar project, components mostly used by the user in other projects, components mostly used by other users with the similar role, top three popular components among all users of the App builder, etc.), and may select (from the one or more storage mediums) a first recommendation model associated with said components. As another example, the first recommendation model may be generated by the recommendation module 111 on-the-fly, based on the user information and/or the components information.

According to embodiments, the first recommendation model may include a sequential recommendation model. Generally, a sequential recommendation model described herein may refer to an algorithm, an artificial intelligence (AI)/machine learning (ML) model, or the like, which may be utilized by the recommendation module 111 (or the at least one processor) to predict or determine the subsequent component(s) that the user is likely to choose based on the user's last known selection of component. Descriptions of several examples of sequential recommendation model utilizable by the recommendation module 111 (or the at least one processor) are described in the following.

According to embodiments, the sequential recommendation model may include a tree-based model which comprises multiple levels or branches, each of the multiple levels may include multiple nodes associated with a respective component, and each of the nodes may have a value assigned thereto. The value may define a probability which the associated component will be chosen by the user.

Referring to FIG. 3A, which illustrates an example of a tree-based model 300, according to one or more embodiments. As illustrated in FIG. 3, the tree-based model 300 may include multiple levels or branches 301 (first level to N level), each of the multiple levels may include multiple nodes 302 each of which is associated with a respective component (e.g., the first level includes nodes associated with components X-Z, etc.), and each of the components/nodes may have a value assigned thereto (e.g., component X has a value of “50%” assigned thereto, etc.).

Simply put, the first level may define components which may be selected by the user in a first user selection, the second level may define components which may be selected by the user in a second user selection (subsequent to the first user selection), and the like. In the example illustrated in FIG. 3A, the tree-based model 300 may be interpreted as: there is a 50% probability that component X will be chosen by the user as the first component, and if component X is being chosen as the first component, there is a 60% probability that component G will be chosen by the user as the second component, and the like.

In this regard, it can be understood that the tree-based model 300 illustrated in FIG. 3A are an example simplified for descriptive purpose, and the model may be different in practice, without departing from the scope of the present disclosure. For instance, each of the multiple levels may have more than three components/nodes, each of the components/nodes may have an associated branch of the next level (e.g., each of the components Y-Z in the first level may have a branch of multiple nodes associated with related components in the second level in a similar manner like component X), the value assigned to each component may be presented in different unit (e.g., “50%” may be replaced with “0.5”, etc.), or the like.

According to embodiments, the sequential recommendation model may include a stochastic-based model which utilizes probability distributions to model or to simulate the uncertainty of user's behavior in choosing or selecting the components over time.

Referring to FIG. 3B, which illustrates an example of a stochastic-based model 310, according to one or more embodiments. In this example, the stochastic-based model 310 includes a Markov chain model, wherein the future state (e.g., future selectable components) of the user's choice or selection may depend only on its current state (e.g., currently selectable components). It can be understood that the stochastic-based model may include any other suitable types of model (e.g., binomial model, etc.), without departing from the scope of the present disclosure.

As illustrated in FIG. 3B, the stochastic-based model 310 may include a table of a transition matrix, wherein the possible components selectable by the user and a value/parameter associated therewith may be represented in the transition matrix. Each element or value in the transition matrix represents the possibility of transitioning from one state to another.

For instance, in the example model 310, the transition matrix may be interpreted as: if the component currently selected by the user is component A, there is a 30% possibility that the user will choose component D in the subsequent choice, a 20% possibility that the user will choose component E in the subsequent choice, a 15% possibility that the user will choose component F in the subsequent choice, and the like. Similarly, if the component currently selected by the user is component B, there is a 20% possibility that the user will choose component D in the subsequent choice, a 22% possibility that the user will choose component E in the subsequent choice, a 18% possibility that the user will choose component F in the subsequent choice, and the like.

Accordingly, the recommendation model 111 (or the at least one processor) may utilize the stochastic-based model to determine or to predict the user's future choice(s) or selection(s) on the components. For instance, based on determining that the user has currently selected component A, the recommendation model 111 (or the at least one processor) may determine, based on the stochastic-based model, the probability of the next selectable components (e.g., components D, E, F, etc.), or the like.

In this regard, it can be understood that the stochastic-based model 310 illustrated in FIG. 3B is merely an example simplified for descriptive purpose, and the model may be different in practice, without departing from the scope of the present disclosure. For instance, the stochastic-based model 310 may include information of all available components and/or all possible combinations of components, the value associated with each element in the stochastic-based model 310 may be presented in different unit (e.g., “30%” may be replaced with “0.3”, etc.), or the like.

The sequential recommendation models described above may be generated and trained by the recommendation module 111 (or the at least one processor) based on historical information such as usage history of the user (e.g., selection or choice previously made by the user), usage history of other user(s), popularity of component(s) in a specific type(s) of project and/or for a specific type(s) of user, and/or the like. In this regards, the values/probability parameters associated with each components in the sequential recommendation models (e.g., values associated with each node in the tree-based model, values associated with elements in the transition matrix of the stochastic-based model, etc.) may be determined, configured, adjusted, customized, or the like, according to the historical information.

Further, the recommendation models may be utilized according to a predetermined patterns (e.g., the first recommendation to-be provided to the user when the user first login to the system may always be determined based on a tree-based model, etc.), based on real-time determination (e.g., based on determining that the user has selected a component included in a recommendation determined based on a Markov chain model, determine a subsequent recommendation based on another Markov chain model and/or based on a tree-based model, etc.), or the like.

According to embodiments, the recommendation module 111 (or the at least one processor) may continuously (or periodically) train and update one or more of the sequential recommendation models described herein. For instance, the sequential recommendation model(s) may be trained or updated every 30 minutes, every 1 hour, every 2 days, or the like. Accordingly, the content in the sequential recommendation model(s) may varies and may be continuously updated.

Referring back to FIG. 2, assuming that, at operation S210, the recommendation module 111 (or the at least one processor) has selected or generated a tree-based, sequential recommendation model (e.g., model 300 in FIG. 3A) as the first recommendation model, the recommendation module 111 (or the at least one processor) may determine at least a portion of the components in the first level of the tree-based model as the components of the first recommendation.

According to embodiments, the recommendation module 111 (or the at least one processor) may determine a ranking of the components in the first level of the tree-based model, and may determine the components of the first recommendation according to the ranking. For instance, the recommendation module may determine the components within the top-three rankings (e.g., top three components which may have the highest probability or possibility of being chosen by the user in the first user selection) as the components of the first recommendation. The ranking may be determined based on the value assigned to each of the components.

In the example illustrated in FIG. 3A, component X has a value of 50%, component Y has a value of 23%, and component Z has a value of 18%. Assuming that the values of said components X-Z are higher than values of other component(s) in the first level or assuming that the first level only contains components X-Z, components X-Z may be selected as components with the top-three rankings, wherein the component X has the first or highest ranking, component Y has the second or middle ranking, and component Z has the third or the lowest ranking, among the three selected components.

It can be understood that the components of the first recommendation may be determined from the first recommendation module in any other suitable manner, without departing from the scope of the present disclosure. Upon determining the first recommendation, method 200 may proceed to operation S220, as described in the following.

### Operation S220: Providing the First Recommendation

Referring to FIG. 2, at operation S220, the first recommendation may be provided to a user. According to embodiments, the first recommendation may be provided to the user via a GUI.

For instance, upon determining the first recommendation at operation S210, the recommendation module 111 may provide the information of the first recommendation (e.g., which components are included in the first recommendation, ranking of each recommended components, etc.) to the interface module 112. According to embodiments, the recommendation module 111 may provide the first recommendation along with information of available components. Alternatively, the interface module 112 may obtain the information of available components from the one or more storage mediums.

Accordingly, the interface module 112 (or the at least one processor performing the functions of the interface module 112) may generate the GUI based on the information of the first recommendation and the information of available components, and may present the GUI to the user.

Referring to FIG. 4A, which illustrates an example GUI 400 presented to the user, according to one or more embodiments. GUI 400 may be generated by and be presented by the interface module 112 (or the at least one processor) to the user.

As illustrated in FIG. 4A, the GUI 400 may include a first partition 410, a second partition 420, a third partition 430, a first interactive element 440, and a second interactive element 450. It can be understood that the GUI 400 may include any suitable additional information or components, and/or may be arranged in a different manner, than as illustrated in FIG. 4A, without departing from the scope of the present disclosure. Further, merely for improving illustration of the recommended components, it is illustrated in FIG. 4A that the components within the first partition 410 are surrounded by a dashed-box. It can be understood that, in practice, the GUI 400 may not include the dashed-box as illustrated in FIG. 4A.

The first partition 410 may include a plurality of interactive elements 411, each of the interactive elements 411 may be associated with a recommended component (e.g., a respective component in the first recommendation). In the example illustrated in FIG. 4A, the first recommendation, which is utilized by the interface module 112 (or the at least one processor) in generating the GUI 400, may be determined based on the tree-based model 300 in FIG. 3A, and the components X-Z in model 300 may be determined as the components of the first recommendation. Thus, in the first partition 410, the interactive elements 411 are associated with components X-Z.

According to embodiments, the interactive elements 411 of the recommended components may be presented in the first partition according to the ranking of each of the recommended components. For instance, the interface module 112 (or the at least one processor) may determine, based on the information of the first recommendation, the ranking of each of the recommended components, and may generate the GUI 400 such that the interactive components of the recommended components are presented sequentially according to the rankings of the recommended components. In the example illustrated in FIG. 4A, the interactive element of component X is presented first, following by the interactive elements of component Y and component Z, since component X has the highest ranking among components X-Z, component Y has the middle ranking among components X-Z, and component Z has the lowest ranking among components X-Z (as described above with reference to operation S210).

Referring still to FIG. 4A, the second partition 420 may include a plurality of interactive elements 421 associated with a portion of the available components and an interactive element 422. The portion of the available components, of which the associated interactive elements are presented in the second partition 420, may be determined or be selected by the interface module 112 (or the at least one processor) in any suitable manner. For instance, the portion of the available components may be randomly selected, may be selected according to the name of components (e.g., component(s) with name starting with alphabet “A” may be selected first, etc.), may be selected according to the date at which the component(s) is added or updated (e.g., component(s) which is most recently added or updated may be selected first, etc.), may be selected according to the type of components (e.g., component(s) associated with function A may be selected first, etc.), or the like.

To this end, each of the interactive elements in the first partition 410 and the second partition 420 may be interactable (e.g., selectable, clickable, etc.) by the user to design and to build an application. For instance, in the example embodiment illustrated in FIG. 4A, the user may drag (e.g., click and hold, etc.) the interactive elements 411 of components X-Z from the first partition 410, and/or may drag the interactive elements 421 of components A-B from the second partition 420, and may then drop said interactive elements to a preview window 431 (will be discussed below with reference to the third partition 430) and appropriately arrange the design of the application (e.g., arranging the location of said interactive element(s) on the preview window, etc.). Alternatively or additionally, the user may click the interactive element 422 to view more or the remaining of available components. According to embodiments, based on determining a user interaction with the interactive element 422, the interface module 112 (or the at least one processor) may generate a pop-up window overlaying a portion of the GUI 400 (e.g., overlaying the second partition 420, etc.) to present additional or the remaining of available components.

In this regard, it can be understood that in the example embodiment illustrated in FIG. 4A, the interactive elements 411 and the interactive elements 421 are presented in the form of interactive block elements, with generic alphabetical references of “Component A”, “Component B”, or the like, presented therein, merely for descriptive and illustrative purposes. In practice, said interactive elements may be presented in any other appropriate manner which may allow the user to distinguish the components associated with the interactive elements.

Referring still to FIG. 4A, the third partition 430 may include a preview window 431. The preview window 431 may show a current design of the application. For instance, the user may drag-and-drop one or more interactive elements from the first partition 410 and/or the second partition 420 to the preview window 431, and may freely adjust the design of the interactive elements (e.g., adjust the size of each element, arrange the location of each element, etc.) therefrom. In the example embodiment illustrated in FIG. 4A, since the user has not yet selected any component, the preview window 431 may include a statement (e.g., “Please insert your first component here.”, etc.) notifying the user to insert an element(s) therein.

The first interactive element 440 may include a “Save” button which, when being interacted by the user, allow the user to save the current design and configuration (e.g., selected components, location of each components, etc.). For instance, based on determining a user interaction on the first interactive element 440, the interface module 112 (or the at least one processor) may collect the information of the components in the preview window 431, and provide the collected information to the one or more storage mediums (e.g., storage module 120) for storing.

On the other hand, the second interactive element 450 may include a “Cancel” button which, when being interacted by the user, allow the user to stop or discard the current progress/current project. According to an embodiment, upon determining a user interaction with the interactive element 460 (e.g., user pressing the “cancel” button, etc.), the interface module 112 (or the at least one processor) may generate and present a pop-up window to query the user for saving the current progress for future use.

In view of the above, at operation S220, the first recommendation may be provided to the user (e.g., via a GUI). Upon providing the first recommendation to the user, method 200 may proceed to operation S230, as described in the following.

### Operation S230: Receiving a User Input

Referring to FIG. 2, at operation S230, a user input may be received. For instance, the interface module 112 (or the at least one processor) may receive a user interaction with an interactive element in the GUI presented to the user (at operation S220).

For instance, the user input may include a user interaction with an interactive element associated with a recommended component (e.g., selection of one of the interactive elements 411 from the first partition 410), a user interaction with an interactive element associated with an available component (e.g., selection of one of the interactive elements 421 from the second partition 420), a user interaction with an interactive element for viewing additional/all available components (e.g., interaction with the interactive element 422), a user interaction with an interactive element for saving the current progress/configuration (e.g. interaction with the interactive element 440), or a user interaction with an interactive element for discarding/terminating the current progress/configuration (e.g., interaction with the interactive element 450).

For descriptive purpose, it may be assumed that the user input includes a user selection of an interactive element from one of (1) the plurality of interactive elements in the first partition and (2) the plurality of interactive elements in the second partition. Upon receiving the user input, method 200 may proceed to operation S240, as described in the following.

### Operation S240: Determining a Second Recommendation

Referring to FIG. 2, at operation S240, a second recommendation of components may be determined. For instance, the interface module 112 may provide the user input (received at operation S230) to the recommendation module 111, and the recommendation module 111 (or the at least one processor) may determine the second recommendation based on the user input.

According to embodiments, the recommendation module 111 (or the at least one processor) may select a subsequent recommendation model based on the user input (e.g., a user selection of the interactive element), and may determine the second recommendation based on the subsequent recommendation model.

According to embodiments, the recommendation module 111 (or the at least one processor) may select the subsequent recommendation model based on the component associated with the interactive element selected by the user.

For instance, at operation S240, the recommendation module 111 (or the at least one processor) may first determine, based on the user input (e.g., user selection), the component associated with the user-selected interactive component. By way of example, the recommendation module 111 (or the at least one processor) may determine whether or not the component associated with the user-selected interactive element is from among the components of the first recommendation.

Subsequently, based on determining that the component associated with the user-selected interactive element is from among the components of the first recommendation, the recommendation module 111 (or the at least one processor) may select or maintain the first recommendation model (e.g., the tree-based model, etc.) utilized in determining the first recommendation as the subsequent recommendation model.

Alternatively, based on determining that the component associated with the user-selected interactive element is not from among the components of the first recommendation, the recommendation module 111 (or the at least one processor) may select a second recommendation model as the subsequent recommendation model, wherein the second recommendation model is different from the first recommendation model. According to embodiments, the second recommendation model may include a stochastic-based mode, such as a Markov chain model, or the like. According to embodiments, the second recommendation model may include another tree-based model with configuration different from the tree-based model utilized in determining the first recommendation (e.g., different levels, different components, different values, etc.).

Upon selecting the subsequent recommendation model, the recommendation module 111 (or the at least one processor) may determine the second recommendation based on the selected subsequent recommendation model.

For instance, assuming that the first recommendation model (e.g., a tree-based recommendation model) is selected or maintained as the subsequent recommendation model, the recommendation module 111 (or the at least one processor) may determine the second recommendations by determining at least a portion of components in the subsequent level of the first recommendation model as the components of the second recommendation.

By way of example, assuming that the user input (received at operation S230) indicates that the user has selected an interactive element associated with component X from the first partition 410, the recommendation module 111 (or the at least one processor) may select or maintain the first recommendation model (e.g., the tree-based model 300 in FIG. 3A utilized in determining the first recommendation) as the subsequent recommendation model, and may determine components G-I (components in the second level of the node of the selected component X) as the components of the second recommendation, in a similar manner as described above with reference to the determining of the first recommendation (at operation S210).

Alternatively, assuming that a stochastic-based model is selected as the subsequent recommendation model, the recommendation module 111 (or the at least one processor) may determine the second recommendations based on the stochastic-based model.

By way of example, assuming that the user input (received at operation S230) indicates that the user has selected an interactive element 421 (e.g., interactive element associated with one of the components A-C) from the second partition 420, the recommendation module 111 (or the at least one processor) may select the stochastic-based model (e.g., model 310 in FIG. 3B) as the subsequent recommendation model. Subsequently, the recommendation module 111 (or the at least one processor) may determine, compute, calculate, or the like, the probability or possibility of each component in the stochastic-based model being chosen by the user in the subsequent selection, and may determine the second recommendation based thereon.

For instance, assuming that the user has selected an interactive element associated with component A, the recommendation module 111 (or the at least one processor) may determine, based on the stochastic-based model, the probability or possibility of each available components being selected in the subsequent user's choice or user's selection, and may choose the components which has the top ranking (e.g., components with the top three highest possibility of being selected, etc.) as the components for including in the second recommendation. Assuming that, based on the stochastic-based model 310 in FIG. 3B, the recommendation module 111 (or the at least one processor) has determined that, after the user has selected component A, the top three components which are most possibly to be selected by the user in the subsequent choice or selection (e.g., the components which has the top three highest value, etc.) are components D-F. In that case, the recommendation module 111 (or the at least one processor) may determine components D-F as the components of the second recommendation.

It can be understood that the examples described above are provided merely for descriptive purpose, and are not intended to be exhaustive or to limit the scope of the present disclosure. Specifically, the recommendation module 111 (or the at least one processor) may select the subsequent recommendation model and/or may determine the second recommendation in any suitable manner different from as described above, without departing from the scope of the present disclosure. For instance, the recommendation module 111 (or the at least one processor) may maintain the first recommendation model (e.g., the tree-based model, etc.) as the subsequent recommendation model based on determining that the component associated with the user-selected interactive element is not from among the components of the first recommendation, the recommendation module 111 (or the at least one processor) may determine the top five components (which are most possibly to be selected by the user in the subsequent choice or selection) as the components of the second recommendation, or the like

Upon determining the second recommendation, method 200 may proceed to operation S250, as described in the following.

### Operation S250: Providing the Second Recommendation

Referring to FIG. 2, at operation S250, the second recommendation may be provided to the user. According to embodiments, the second recommendation may be provided to the user via a GUI.

For instance, upon determining the second recommendation at operation S240, the recommendation module 111 may provide the information of the second recommendation (e.g., which components are included in the second recommendation, ranking of each recommended components, etc.) to the interface module 112. Accordingly, the interface module 112 (or the at least one processor performing the functions of the interface module 112) may generate the GUI based on the second recommendation and the information of available components, and may present the GUI to the user, in a similar manner as described above with reference to operation S220. In some implementations, the interface module 112 (or the at least one processor) may update a GUI presented to the user to include the information of the second recommendation. For instance, the interface module 112 (or the at least one processor) may update the GUI 400 in FIG. 4A such that the first portion 410 includes information of the components of the second recommendation.

FIG. 4B and FIG. 4C each illustrates an example GUI which may be generated and presented to the user for providing the second recommendation under different circumstances. Each of the GUIs in FIG. 4B and FIG. 4C may be an updated version of GUI 400 in FIG. 4A and may include one or more elements or information (e.g., first partition 410, second partition 420, third partition 430, etc.) similar to those presented in GUI 400. Thus, redundant descriptions associated therewith may be omitted below for conciseness.

Referring first to FIG. 4B, which illustrates an example GUI 401 presented to the user, according to one or more embodiments.

GUI 401 in FIG. 4B may be an updated version of GUI 400 in FIG. 4A, and may be generated and presented by the interface module 112 (or the at least one processor) upon a user selection on the interactive element associated with component X in the first partition 410 of GUI 400 in FIG. 4A.

In this regard, the first partition 410 of the GUI 401 may include a plurality of interactive elements 412, each of which is associated with a respective component of components of the second recommendation (e.g., components G-I), and the preview window 431 of the third partition 430 may show the interactive element 432 (associated with the selected component X) and the configuration of the selected component (e.g., current location of component X, size of component X, etc.).

Referring next to FIG. 4C, which illustrates an example GUI 402 presented to the user, according to one or more embodiments.

GUI 402 in FIG. 4C may be an updated version of GUI 400 in FIG. 4A, and may be generated and presented by the interface module 112 (or the at least one processor) upon a user selection on the interactive element associated with component A in the second partition 420 of GUI 400 in FIG. 4A.

In this regard, the first partition 410 of the GUI 402 may include a plurality of interactive elements 413, each of which is associated with a respective component of the components of the second recommendation (e.g., components D-F), and the preview window 431 of the third partition 430 may show the interactive element 433 (associated with the selected component A) and the configuration of the selected component (e.g., current location of component A, size of component A, etc.).

It can be understood that the interactive elements of the recommended components (e.g., components G-I in GUI 401 of FIG. 4B, components D-F in GUI 402 of FIG. 4C, etc.) may be presented in the first partition according to the ranking of each of the recommended components, in a similar manner as described above with reference to operation S220.

Referring back to FIG. 2, upon providing the second recommendation to the user at operation S250, operations similar to operations S230-S250 may be repeated or be performed iteratively by the recommendation module 111 and interface module 112 (or the at least one processor) to continuously provide subsequent recommendation(s), such as a third recommendation, a fourth recommendation, or the like, until determining an event (e.g., until after the user has completed building the application, until the user has save/cancel the current progress, etc.). In this regard, any suitable recommendation model(s) may be utilized for determining any of the subsequent recommendation(s). For instance, the third recommendation may be determined based on the tree-based model 300 in FIG. 3A, based on the stochastic-based model 310 in FIG. 3B, based on a sequential recommendation model different from those illustrated in FIG. 3A and FIG. 3B, or the like, without departing from the scope of the present disclosure.

Further, the user input received after providing each recommendation may be utilized for training the recommendation model(s), so as to continuously update the associated recommendation model(s). In view of the above, example embodiments of the present disclosure may provide unique, real-time or near real-time, and customized components recommendation(s) to the user of the App builder.

### Example Implementation Environment and Device

FIG. 5 illustrates a diagram of an example environment 500 in which systems and/or methods, described herein, may be implemented, according to one or more embodiments. As shown in FIG. 5, environment 500 may include a user device 510, a platform 520, and a network 530. Devices of environment 500 may interconnect via wired connections, wireless connections, or a combination of wired and wireless connections.

User device 510 may include one or more devices capable of receiving, generating, storing, processing, and/or providing information associated with platform 520. For example, user device 510 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 510 may receive information from and/or transmit information to platform 520. According to embodiments, user device 510 may corresponds to user module (e.g., user module 130) described hereinabove, thus the descriptions associated therewith may be applicable to each other, unless being explicitly described otherwise.

Platform 520 may include one or more devices capable of receiving, generating, storing, processing, and/or providing information. In some implementations, platform 520 may include a cloud server or a group of cloud servers. In some implementations, platform 520 may be designed to be modular such that certain software components may be swapped in or out depending on a particular need. As such, platform 520 may be easily and/or quickly reconfigured for different uses.

According to embodiments, the App builder 110 (or one or more modules included therein) and/or the storage module 120 may be deployed or hosted in the platform 520. In this regard, a user may utilize the user device 510 to access and to utilize, via network 530, the App builder 110 and/or the storage module 120 deployed or hosted in platform 520.

In some implementations, as shown, platform 520 may be hosted in cloud computing environment 522. Notably, while implementations described herein describe platform 520 as being hosted in cloud computing environment 522, in some implementations, platform 520 may not be cloud-based (i.e., may be implemented outside of a cloud computing environment) or may be partially cloud-based.

Cloud computing environment 522 includes an environment that hosts platform 520. Cloud computing environment 522 may provide computation, software, data access, storage, etc. services that do not require end-user (e.g., user device 510) knowledge of a physical location and configuration of system(s) and/or device(s) that hosts platform 520. As shown, cloud computing environment 522 may include a group of computing resources 524 (referred to collectively as “computing resources 524” and individually as “computing resource 524”).

Computing resource 524 includes one or more personal computers, a cluster of computing devices, workstation computers, server devices, or other types of computation and/or communication devices. In some implementations, computing resource 524 may host platform 520. The cloud resources may include compute instances executing in computing resource 524, storage devices provided in computing resource 524, data transfer devices provided by computing resource 524, etc. In some implementations, computing resource 524 may communicate with other computing resources 524 via wired connections, wireless connections, or a combination of wired and wireless connections.

As further shown in FIG. 5, computing resource 524 includes a group of cloud resources, such as one or more applications (“APPs”) 524-1, one or more virtual machines (“VMs”) 524-2, virtualized storage (“VSs”) 524-3, one or more hypervisors (“HYPs”) 524-4, or the like.

Application 524-1 includes one or more software applications that may be provided to or accessed by user device 510. Application 524-1 may eliminate a need to install and execute the software applications on user device 510. For example, application 524-1 may include software associated with platform 520 and/or any other software capable of being provided via cloud computing environment 522. In some implementations, one application 524-1 may send/receive information to/from one or more other applications 524-1, via virtual machine 524-2.

Virtual machine 524-2 includes a software implementation of a machine (e.g., a computer) that executes programs like a physical machine. Virtual machine 524-2 may be either a system virtual machine or a process virtual machine, depending upon use and degree of correspondence to any real machine by virtual machine 524-2. A system virtual machine may provide a complete system platform that supports execution of a complete operating system (“OS”). A process virtual machine may execute a single program, and may support a single process. In some implementations, virtual machine 524-2 may execute on behalf of a user (e.g., user device 510), and may manage infrastructure of cloud computing environment 522, such as data management, synchronization, or long-duration data transfers.

Virtualized storage 524-3 includes one or more storage systems and/or one or more devices that use virtualization techniques within the storage systems or devices of computing resource 524. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 524-4 may provide hardware virtualization techniques that allow multiple operating systems (e.g., “guest operating systems”) to execute concurrently on a host computer, such as computing resource 524. Hypervisor 524-4 may present a virtual operating platform to the guest operating systems, and may manage the execution of the guest operating systems. Multiple instances of a variety of operating systems may share virtualized hardware resources.

Network 530 includes one or more wired and/or wireless networks. For example, network 530 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

In view of the above, any of the configurations, functions and operations described with reference to FIG. 1 to FIG. 4C above may be deployed in or performed by any combination of elements illustrated in FIG. 5. For instance, as described, the App builder 110 (or one or more modules included therein) and/or the storage module 120 may be deployed in the platform 520, and the like.

The number and arrangement of devices and networks shown in FIG. 5 are provided as an example. In practice, there may be additional devices and/or networks, fewer devices and/or networks, different devices and/or networks, or differently arranged devices and/or networks than those shown in FIG. 5. Furthermore, two or more devices shown in FIG. 5 may be implemented within a single device, or a single device shown in FIG. 5 may be implemented as multiple, distributed devices. Additionally, or alternatively, a set of devices (e.g., one or more devices) of environment 500 may perform one or more functions described as being performed by another set of devices of environment 500.

FIG. 6 illustrates a diagram of example components of a device 600, according to one or more embodiments. As shown in FIG. 6, device 600 may include a bus 610, a processor 620, a memory 630, a storage component 640, an input component 650, an output component 660, and a communication interface 670.

In embodiments, any of the configurations, functions and operations described with reference to FIG. 1 to FIG. 5 above may be performed by any combination of elements illustrated in FIG. 6. For instance, the device 600 may corresponds to user module 130 and/or storage module 120 in FIG. 1, may corresponds to an apparatus with the App builder 110 in FIG. 1 deployed therein, or the like.

Bus 610 may include a component that permits communication among the components of device 600. Processor 620 may be implemented in hardware, firmware, or a combination of hardware and software. Processor 620 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 620 may include one or more processors capable of being programmed to perform a function. Memory 630 may include a random access memory (RAM), a read only memory (ROM), and/or another type of dynamic or static storage device (e.g., a flash memory, a magnetic memory, and/or an optical memory) that stores information and/or instructions for use by processor 620.

Storage component 640 may store information and/or software related to the operation and use of device 600. For example, storage component 640 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 650 may include a component that permits device 600 to receive information, such as via user input (e.g., a touch screen display, a keyboard, a keypad, a mouse, a button, a switch, and/or a microphone). Additionally, or alternatively, input component 650 may include a sensor for sensing information (e.g., a global positioning system (GPS) component, an accelerometer, a gyroscope, and/or an actuator). Output component 660 may include a component that provides output information from device 600 (e.g., a display, a speaker, and/or one or more light-emitting diodes (LEDs)).

Communication interface 670 may include a transceiver-like component (e.g., a transceiver and/or a separate receiver and transmitter) that enables device 600 to communicate with other devices, such as via a wired connection, a wireless connection, or a combination of wired and wireless connections. Communication interface 670 may permit device 600 to receive information from another device and/or provide information to another device. For example, communication interface 670 may include an Ethernet interface, an optical interface, a coaxial interface, an infrared interface, a radio frequency (RF) interface, a universal serial bus (USB) interface, a Wi-Fi interface, a cellular network interface, or the like.

Device 600 may perform one or more processes described herein. Device 600 may perform these processes in response to processor 620 executing software instructions stored by a non-transitory computer-readable medium, such as memory 630 and/or storage component 640. A computer-readable medium is defined herein as a non-transitory memory device. A memory device includes memory space within a single physical storage device or memory space spread across multiple physical storage devices.

Software instructions may be read into memory 630 and/or storage component 640 from another computer-readable medium or from another device via communication interface 670. When executed, software instructions stored in memory 630 and/or storage component 640 may cause processor 620 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

### Various Aspects of Embodiments

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

Various further respective aspects and features of embodiments of the present disclosure may be defined by the following items:

Item [1]: An apparatus including: at least one memory storage storing computer-executable instructions; and at least one processor communicatively coupled to the memory storage, wherein the at least one processor may be configured to execute the computer-executable instructions to: determine a first recommendation of components among multiple available components; provide the first recommendation to a user; receive a user input from the user; determine, based on the user input, a second recommendation of components among the available components; and provide the second recommendation to the user.

Item [2]: The apparatus according to item [1], wherein the at least one processor may be configured to execute the computer-executable instructions to determine the first recommendation by: obtaining at least one of information of the available components and information of the user; selecting, based on the at least one of the information of the available components and the information of the user, a first recommendation model, wherein the first recommendation model may include a tree-based model including multiple levels, each of the multiple levels may include a plurality of components; and determining at least a portion of a plurality of components in a first level of the tree-based model as the components of the first recommendation.

Item [3]: The apparatus according to any one of items [1]-[2], wherein the at least one processor may be configured to execute the computer-executable instructions to provide the first recommendation by: generating a graphical user interface (GUI) includes a first partition, wherein the first partition may include a plurality of interactive elements, each of which may be associated with a respective component of the components of the first recommendation; and presenting the GUI to the user.

Item [4]: The apparatus according to item [3], wherein the GUI may include a second partition, wherein the second partition may include a plurality of interactive elements, each of which may be associated with a respective components of the available components.

Item [5]: The apparatus according to item [4], wherein the at least one processor may be configured to execute the computer-executable instructions to receive the user input by: receiving a user selection of an interactive element from one of (1) the plurality of interactive elements in the first partition and (2) the plurality of interactive elements in the second partition.

Item [6]: The apparatus according to item [5], wherein the at least one processor may be configured to execute the computer-executable instructions to determine the second recommendation by: selecting a subsequent recommendation model based on the user selection; and determining, based on the subsequent recommendation model, the second recommendation.

Item [7]: The apparatus according to item [6], wherein the at least one processor may be configured to execute the computer-executable instructions to select the subsequent recommendation model by: determining, based on the user selection, a component associated with the interactive element selected by the user; based on determining that the component associated with the user-selected interactive element is from among the components of the first recommendation, selecting the first recommendation model as the subsequent recommendation model; and based on determining that the component associated with the user-selected interactive element is not from among the components of the first recommendation, selecting a second recommendation model as the subsequent recommendation model, wherein the second recommendation model may be different from the first recommendation model.

Item [8]: The apparatus according to any one of items [6]-[7], wherein the first recommendation model is selected as the subsequent recommendation model, and wherein the at least one processor may be configured to execute the computer-executable instructions to determine the second recommendation by: determining at least a portion of a plurality of components in a second level of the tree-based model as the components of the second recommendation.

Item [9]: The apparatus according to item [7], wherein the second recommendation model may include a Markov chain model.

Item [10]: The apparatus according to any one of items [3]-[9], wherein the at least one processor may be configured to execute the computer-executable instructions to provide the second recommendation by: updating the GUI, wherein a first partition of the updated GUI may include a plurality of interactive elements, each of which may be associated with a respective component of the components of the second recommendation; and presenting the updated GUI to the user.

Item [11]: A method, performed by at least one processor, including: determining a first recommendation of components among multiple available components; providing the first recommendation to a user; receiving a user input from the user; determining, based on the user input, a second recommendation of components among the available components; and providing the second recommendation to the user.

Item [12]: The method according to item [11], wherein the determining the first recommendation may include: obtaining at least one of information of the available components and information of the user; selecting, based on the at least one of the information of the available components and the information of the user, a first recommendation model, wherein the first recommendation model may include a tree-based model including multiple levels, each of the multiple levels may include a plurality of components; and determining at least a portion of a plurality of components in a first level of the tree-based model as the components of the first recommendation.

Item [13]: The method according to any one of items [11]-[12] wherein the providing the first recommendation may include: generating a graphical user interface (GUI) includes a first partition, wherein the first partition may include a plurality of interactive elements, each of which may be associated with a respective component of the components of the first recommendation; and presenting the GUI to the user.

Item [14]: The method according to item [13], wherein the GUI may include a second partition, wherein the second partition may include a plurality of interactive elements, each of which may be associated with a respective components of the available components.

Item [15]: The method according to item [14], wherein the receiving the user input may include: receiving a user selection of an interactive element from one of (1) the plurality of interactive elements in the first partition and (2) the plurality of interactive elements in the second partition.

Item [16]: The method according to item [15], wherein the determining the second recommendation may include: selecting a subsequent recommendation model based on the user selection; and determining, based on the subsequent recommendation model, the second recommendation.

Item [17]: The method according to item [16], wherein the selecting the subsequent recommendation model may include: determining, based on the user selection, a component associated with the interactive element selected by the user; based on determining that the component associated with the user-selected interactive element is from among the components of the first recommendation, selecting the first recommendation model as the subsequent recommendation model; and based on determining that the component associated with the user-selected interactive element is not from among the components of the first recommendation, selecting a second recommendation model as the subsequent recommendation model, wherein the second recommendation model may be different from the first recommendation model.

Item [18]: The method according to any one of items [16]-[17], wherein the first recommendation model is selected as the subsequent recommendation model, and wherein the determining the second recommendation may include: determining at least a portion of a plurality of components in a second level of the tree-based model as the components of the second recommendation.

Item [19]: The method according to item [17], wherein the second recommendation model may include a Markov chain model.

Item [20]: The method according to any one of items [13]-[19,] wherein the providing the second recommendation may include: updating the GUI, wherein a first partition of the updated GUI may include a plurality of interactive elements, each of which may be associated with a respective component of the components of the second recommendation; and presenting the updated GUI to the user.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. An apparatus comprising:
at least one memory storage storing computer-executable instructions; and
at least one processor communicatively coupled to the memory storage, wherein the at least one processor is configured to execute the computer-executable instructions to:
determine a first recommendation of components among multiple available components;
provide the first recommendation to a user;
receive a user input from the user;
determine, based on the user input, a second recommendation of components among the available components; and
provide the second recommendation to the user.

2. The apparatus according to claim 1, wherein the at least one processor is configured to execute the computer-executable instructions to determine the first recommendation by:
obtaining at least one of information of the available components and information of the user;
selecting, based on the at least one of the information of the available components and the information of the user, a first recommendation model, wherein the first recommendation model comprises a tree-based model including multiple levels, each of the multiple levels comprises a plurality of components; and
determining at least a portion of a plurality of components in a first level of the tree-based model as the components of the first recommendation.

3. The apparatus according to claim 1, wherein the at least one processor is configured to execute the computer-executable instructions to provide the first recommendation by:
generating a graphical user interface (GUI) comprises a first partition, wherein the first partition comprises a plurality of interactive elements, each of which is associated with a respective component of the components of the first recommendation; and
presenting the GUI to the user.

4. The apparatus according to claim 3, wherein the GUI comprises a second partition, wherein the second partition comprises a plurality of interactive elements, each of which is associated with a respective components of the available components.

5. The apparatus according to claim 4, wherein the at least one processor is configured to execute the computer-executable instructions to receive the user input by:
receiving a user selection of an interactive element from one of (1) the plurality of interactive elements in the first partition and (2) the plurality of interactive elements in the second partition.

6. The apparatus according to claim 5, wherein the at least one processor is configured to execute the computer-executable instructions to determine the second recommendation by
selecting a subsequent recommendation model based on the user selection; and
determining, based on the subsequent recommendation model, the second recommendation.

7. The apparatus according to claim 6, wherein the at least one processor is configured to execute the computer-executable instructions to select the subsequent recommendation model by:
determining, based on the user selection, a component associated with the interactive element selected by the user;
based on determining that the component associated with the user-selected interactive element is from among the components of the first recommendation, selecting the first recommendation model as the subsequent recommendation model; and
based on determining that the component associated with the user-selected interactive element is not from among the components of the first recommendation, selecting a second recommendation model as the subsequent recommendation model, wherein the second recommendation model is different from the first recommendation model.

8. The apparatus according to claim 6, wherein the first recommendation model is selected as the subsequent recommendation model, and wherein the at least one processor is configured to execute the computer-executable instructions to determine the second recommendation by: determining at least a portion of a plurality of components in a second level of the tree-based model as the components of the second recommendation.

9. The apparatus according to claim 7, wherein the second recommendation model comprises a Markov chain model.

10. The apparatus according to claim 3, wherein the at least one processor is configured to execute the computer-executable instructions to provide the second recommendation by:
updating the GUI, wherein a first partition of the updated GUI comprises a plurality of interactive elements, each of which is associated with a respective component of the components of the second recommendation; and
presenting the updated GUI to the user.

11. A method, performed by at least one processor, comprising:
determining a first recommendation of components among multiple available components;
providing the first recommendation to a user;
receiving a user input from the user;
determining, based on the user input, a second recommendation of components among the available components; and
providing the second recommendation to the user.

12. The method according to claim 11, wherein the determining the first recommendation comprises:
obtaining at least one of information of the available components and information of the user;
selecting, based on the at least one of the information of the available components and the information of the user, a first recommendation model, wherein the first recommendation model comprises a tree-based model including multiple levels, each of the multiple levels comprises a plurality of components; and
determining at least a portion of a plurality of components in a first level of the tree-based model as the components of the first recommendation.

13. The method according to claim 11, wherein the providing the first recommendation comprises:
generating a graphical user interface (GUI) comprises a first partition, wherein the first partition comprises a plurality of interactive elements, each of which is associated with a respective component of the components of the first recommendation; and
presenting the GUI to the user.

14. The method according to claim 13, wherein the GUI comprises a second partition, wherein the second partition comprises a plurality of interactive elements, each of which is associated with a respective components of the available components.

15. The method according to claim 14, wherein the receiving the user input comprises:
receiving a user selection of an interactive element from one of (1) the plurality of interactive elements in the first partition and (2) the plurality of interactive elements in the second partition.

16. The method according to claim 15, wherein the determining the second recommendation comprises:
selecting a subsequent recommendation model based on the user selection; and
determining, based on the subsequent recommendation model, the second recommendation.

17. The method according to claim 16, wherein the selecting the subsequent recommendation model comprises:
determining, based on the user selection, a component associated with the interactive element selected by the user;
based on determining that the component associated with the user-selected interactive element is from among the components of the first recommendation, selecting the first recommendation model as the subsequent recommendation model; and
based on determining that the component associated with the user-selected interactive element is not from among the components of the first recommendation, selecting a second recommendation model as the subsequent recommendation model, wherein the second recommendation model is different from the first recommendation model.

18. The method according to claim 16, wherein the first recommendation model is selected as the subsequent recommendation model, and wherein the determining the second recommendation comprises:
determining at least a portion of a plurality of components in a second level of the tree-based model as the components of the second recommendation.

19. The method according to claim 7, wherein the second recommendation model comprises a Markov chain model.

20. The method according to claim 13, wherein the providing the second recommendation comprises:
updating the GUI, wherein a first partition of the updated GUI comprises a plurality of interactive elements, each of which is associated with a respective component of the components of the second recommendation; and
presenting the updated GUI to the user.
